(19) United States
(12) Patent Application Publication
(10) Pub. No.: US 2022/0252836 A1
(43) Pub. Date: Aug. 11, 2022

(54) OPTICAL IMAGING DEVICE, IMAGING MODULE, AND ELECTRONIC DEVICE

(71) Applicant: HON HAI PRECISION INDUSTRY CO., LTD., New Taipei (TW)

(72) Inventors: GWO-YAN HUANG, New Taipei (TW); CHING-HUNG CHO, New Taipei (TW); HSING-CHEN LIU, New Taipei (TW)

(21) Appl. No.: 17/585,806

(22) Filed: Jan. 27, 2022

(30) Foreign Application Priority Data
Feb. 9, 2021 (CN) 202110178241.5

(51) Int. Cl. G02B 13/00; G02B 9/34

(52) U.S. Cl. CPC G02B 13/004; G02B 9/34

(57) ABSTRACT

A compact multi-lens optical imaging device having high resolution in both near-sight and far-sight, for use in an electronic device, is composed of first to fourth lenses having positive and negative refractive powers and a filter. The optical imaging module satisfies formula 0.4<Imgh/f<1.4, 0.7<TL/f<2, Imgh being a half of an image height corresponding to a maximum field of view of the optical imaging device, f being an effective focal length of the optical imaging device, and TL being a distance from an object-side surface of the first lens to an image plane of the optical imaging device along the optical axis.

### FIELD

The subject matter relates to optical technologies, and more particularly, to an optical imaging device, an imaging module having the optical imaging device, and an electronic device having the imaging module.

### BACKGROUND

The image pick up lens has an increasingly wide range of application, there is great demand in different fields for the small image pick-up lens having high resolution, particularly in cell phone, digital camera, or visual detection system for car parking or other purposes.

A photosensitive element for a fixed focus lens generally includes a charge coupled device (CCD) or a complementary metal oxide semiconductor (CMOS), and its light sensitivity will be reduced sharply with the increase of exit angle of the lens. Therefore, the fixed focus lens is usually consisted of three to four lenses. However, a stable imaging quality of such fixed focus lens is problematic.

### BRIEF DESCRIPTION OF THE DRAWINGS

Implementations of the present technology will now be described, by way of example only, with reference to the attached figures.

FIG. 1 is a diagrammatic view of a first embodiment of an optical imaging device according to the present disclosure.

FIG. 2 is a diagram of field curvatures and distortions of the optical imaging device in the first embodiment.

FIG. 3 is a diagrammatic view of a second embodiment of an optical imaging device according to the present disclosure.

FIG. 4 is a diagram of field curvatures and distortions of the optical imaging device in the second embodiment.

FIG. 5 is a diagrammatic view of a third embodiment of an optical imaging device according to the present disclosure.

FIG. 6 is a diagram of field curvatures and distortions of the optical imaging device in the third embodiment.

FIG. 7 is a diagrammatic view of a fourth embodiment of an optical imaging device according to the present disclosure.

FIG. 8 is a diagram of field curvatures and distortions of the optical imaging device in the fourth embodiment.

FIG. 9 is a diagrammatic view of a fifth embodiment of an optical imaging device according to the present disclosure.

FIG. 10 is a diagram of field curvatures and distortions of the optical imaging device in the fifth embodiment.

FIG. 11 is a diagrammatic view of a sixth embodiment of an optical imaging device according to the present disclosure.

FIG. 12 is a diagram of field curvatures and distortions of the optical imaging device in the sixth embodiment.

FIG. 13 is a diagrammatic view of an embodiment of an imaging module according to the present disclosure.

FIG. 14 is a diagrammatic view of an embodiment of an electronic device using optical imaging device in one embodiment according to the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The terms “first” and “second” are merely intended for a purpose of description, and shall not be understood as an indication or implication of relative importance or an implicit indication of a quantity of indicated technical features. Therefore, a feature modified by “first” or “second” may explicitly or implicitly include one or more such features. In the descriptions of the present invention, unless otherwise indicated, the meaning of “multiple” is two or more.

The term “comprising,” when utilized, means “including, but not necessarily limited to”; it specifically indicates open-ended inclusion or membership in the so-described combination, group, series, and the like.

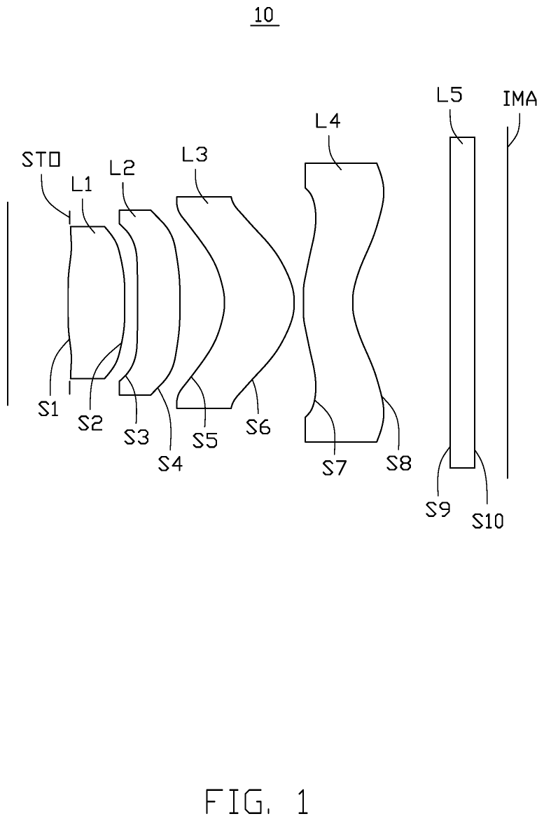

Referring to FIG. 1, a first embodiment of an optical imaging device 10 is provided. The optical imaging device 10 includes, from an object side to an image side, a first lens L1, a second lens L2, a third lens L3, and a fourth lens L4. Each of the first lens L1, the second lens L2, the third lens L3 and the fourth lens L4 is substantially a meniscus lens.

The first lens L1 has a refractive power and includes an object-side surface S1 and an image-side surface S2. The second lens L2 has a negative refractive power and includes an object-side surface S3 and an image-side surface S4. The third lens L3 has a positive refractive power and includes an object-side surface S5 and an image-side surface S6. The object-side surface S5 is concave near an optical axis of the optical imaging device 10. The fourth lens L4 has a positive refractive power and includes an object-side surface S7 and an image-side surface S8, the image-side surface S10 is concave near the optical axis.

The optical imaging device 10 satisfies the following formulas (1):

0.4<Imgh/f<1.4 and 0.7<TL/f<2 (formulas (1)), Imgh is a half of an image height corresponding to a maximum field of view of the optical imaging device 10, f is an effective focal length of the optical imaging device 10, and TL is a distance from the object-side surface S1 of the first lens L1 to an image plane of the optical imaging device 10 along the optical axis.

Controlling the values of Imgh/f and TL/f improves an image resolution of the optical imaging device 10, an imaging quality of the optical imaging device 10 can be stable, a total optical length of the optical imaging device 10 can be shortened, so that the optical imaging device 10 can be lightweight and compact.

Through arrangement of the refractive powers and the contouring of each lens, performance of each lens is increased, image error and image degradation are reduced, and the image resolution of the optical imaging device 10 is improved.

In some embodiments, the optical imaging device 10 also includes a stop STO disposed on a surface of any one of the lenses L1 to L4. The stop STO can also be disposed before the first lens L1. The stop STO can also be sandwiched between any two lenses. The stop STO can also be disposed on the image-side surface S8 of the fourth lens L4. For example, as shown in FIG. 1, the stop STO is disposed on the object-side surface S1 of the first lens L1.

In some embodiments, the optical imaging device 10 also includes an optical filter L5. The optical filter L5 includes an object-side surface S9 and an image-side surface S10. The optical filter L5 is arranged on the image-side surface of the fourth lens L4. The optical filter L6 can filter out visible rays and only allow infrared rays to pass through, so that the optical imaging device 10 can also be used in a dark environment.

It should be understood, in other embodiments, the optical filter 15 can filter out infrared rays and only allow visible rays to pass through, so that the optical imaging device 10 can be used in a bright environment.

In some embodiments, the object-side surface S3 and the image-side surface S4 of the second lens L2 are aspherical, the object-side surface S5 and the image-side surface S6 of the third lens L3 are aspherical, and the object-side surface S7 and the image-side surface S8 of the fourth lens L4 are aspherical. As such, most spherical aberrations of the optical imaging device 10 are eliminated and the imaging quality of the optical imaging device 10 is improved.

In some embodiments, the object-side surface S1 of the first lens L1 is convex near the optical axis, the image-side surface S2 of the first lens L1 is convex near the optical axis. As such, through arrangement of the contouring of the first lens L1, the performances of the first lens 11 can be ensured, and the image resolution of the optical imaging device 10 can be improved.

In some embodiments, each of the second lens L2, the third lens L3, and the fourth lens L4 is made of plastic. As such, each lens of the optical imaging device 10 is easier in manufacture, which can effectively reduce the cost and improve the product yield.

In some embodiment, the optical imaging device 10 satisfies the following formula (2):

0.6<TL2/f<1.8 (formula (2)), TL2 is a distance from the object-side surface S3 of the second lens L2 to the image plane IMA of the optical imaging device 10 along the optical axis. As such, the total optical length of the optical imaging device 10 can be shortened.

In some embodiment, the optical imaging device 10 satisfies the following formula (3):

0.3<TL3/f<1 (formula (3)), TL3 is a distance from the object-side surface S5 of the third lens L3 to the image plane IMA of the optical imaging device 10 along the optical axis. As such, the total optical length of the optical imaging device 10 can be shortened.

In some embodiment, the optical imaging device 10 satisfies the following formula (4):

0.1<TL4/f<0.5 (formula (4)), TL4 is a distance from the object-side surface S7 of the fourth lens L4 to the image plane IMA of the optical imaging device 10 along the optical axis. As such, the total optical length of the optical imaging device 10 can be shortened.

In some embodiment, the optical imaging device 10 satisfies the following formula (5):

1.1<f/EPD<3.9 (formula (5)), EPD is an entrance pupil diameter of the optical imaging device 10. As such, the light admitted to the optical imaging device 10 and a F-number of the optical imaging device 10 can be controlled, so that the optical imaging device 10 can have high resolution for nearby objects and the imaging quality of the optical imaging device 10 can be improved.

In some embodiment, the optical imaging device 10 satisfies the following formula (6):

0.42<V1/(V2+V3+V4)<0.44 (formula (6)), V1 is a dispersion coefficient of the first lens L1, V2 is a dispersion coefficient of the second lens L2, V3 is a dispersion coefficient of the third lens L3, and V4 is a dispersion coefficient of the fourth lens L4. This formula achieves a balance between chromatic aberration correction and astigmatism correction, which can improve the imaging quality of the optical imaging device 10.

### First Embodiment

Referring to FIG. 1, the optical imaging device 10 includes, from the object side to the image side, a stop STO, a first lens L1 with a positive refractive power, a second lens L2 with a negative refractive power, a third lens L3 with a positive refractive power, a fourth lens L4 with a positive refractive power, and an optical filter L5.

The first lens L1, the second lens L2, the third lens L3, and the fourth lens L4 are made of plastic, and the optical filter L5 is made of glass.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is concave near the optical axis, and the image-side surface S6 of the third lens L3 is convex near the optical axis. The object-side surface S7 of the fourth lens L4 is concave near the optical axis, and the image-side surface S8 of the fourth lens L4 is convex near the optical axis.

A light dispersion coefficient of the first lens L1 is 55.978, the dispersion coefficient of the second lens L2 is 20.373, the dispersion coefficient of the third lens L3 is 55.978, and the dispersion coefficient of the fourth lens L4 is 55.978.

When the optical imaging device 10 is used, rays from the object side enter the optical imaging device 10, successively pass through the stop STO, the first lens L1, the second lens L2, the third lens L3, the fourth lens L4, and the optical filter L5, and finally converge on the image plane IMA.

Table 1 shows characteristics of the optical imaging device 10. The reference wavelength of focal length, refractive index, and Abbe number is 558 nm, and the units of radius of curvature, thickness, and semi-diameter are in millimeters (mm).

TABLE 1
First embodiment
f = 1.732 mm, TL = 2.296 mm, TL2 = 1.970 mm, TL3 = 1.283 mm, TL4 = 0.931 mm

| | | Type of | radius of | | | refractive | Abbe | semi- |
|---|---|---|---|---|---|---|---|---|
| Surface | Lens | surface | curvature | thickness | material | index | number | diameter |
| object- | | standard surface | infinite | 300.000 | | | | 208.487 |
| side | | | | | | | | |
| surface | | | | | | | | |
| STO | | standard surface | infinite | 0.015 | | | | 0.434 |
| S1 | first lens | aspheric surface | 2.577 | 0.342 | plastic | 1.54 | 56 | 0.439 |
| S2 | | aspheric surface | −3.448 | 0.076 | | | | 0.522 |
| S3 | second lens | aspheric surface | 16.113 | 0.250 | plastic | 1.66 | 20.4 | 0.538 |
| S4 | | aspheric surface | −5.565 | 0.268 | | | | 0.632 |
| S5 | third lens | aspheric surface | −0.620 | 0.419 | plastic | 1.54 | 56 | 0.668 |
| S6 | | aspheric surface | −0.493 | 0.051 | | | | 0.726 |
| S7 | fourth lens | aspheric surface | 0.899 | 0.301 | plastic | 1.54 | 56 | 0.788 |
| S8 | | aspheric surface | 0.494 | 0.581 | | | | 0.953 |
| S9 | optical filter | standard surface | infinite | 0.150 | glass | 1.52 | 64.2 | 1.101 |
| S10 | | standard surface | infinite | 0.200 | | | | 1.133 |
| IMA | | standard surface | infinite | | | | | 0.000 |

f is the effective focal length of the optical imaging device 10, TL is the distance from the object-side surface S1 of the first lens L1 to the image plane IMA of the optical imaging device 10 along the optical axis, TL2 is the distance from the object-side surface S3 of the second lens L2 to the image plane IMA of the optical imaging device 10 along the optical axis, TL3 is the distance from the object-side surface S5 of the third lens L3 to the image plane IMA of the optical imaging device 10 along the optical axis, and TL4 is the distance from the object-side surface S7 of the fourth lens L4 to the image plane IMA of the optical imaging device 10 along the optical axis.

The surface of each of the first lens L1, the second lens L2, the third lens L3, and the fourth lens L4 is aspherical. The contouring Z of each aspherical surface can be defined by, but is not limited to, the aspherical equation which satisfies the following formula (7):

$$Z = \frac{{cr}^{2}}{1 + \sqrt{1 - ( k + 1 ) {c}^{2} {r}^{2}}} + \sum {Air}^{i} . \qquad ( formula ( 7 ) )$$

Z is a distance between any point on the aspheric surface and the vertex of the aspheric surface along the optical axis, r is a vertical distance from any point on the aspheric surface to the optical axis, c is a curvature (reciprocal of the radius of curvature) of the vertex, k is a conic constant, and Ai is a correction coefficient of i-th order of the aspheric surface. For simplicity, these definitions apply to all embodiments of this disclosure. Table 2 shows the conic constant k and the high-order coefficients A4, A6, A8, A10, A12, A14, A16, A18, and A20 for the surfaces S1 to S8 of each aspheric lens in the first embodiment.

TABLE 2
aspherical coefficients

| surface | k | A4 | A6 | A8 | A10 | A12 | A14 | A16 | A18 | A20 |
|---|---|---|---|---|---|---|---|---|---|---|
| S1 | 2.329 | −0.074 | −2.262 | −1.710 | 25.754 | −54.522 | 23.217 | 138.430 | −1.578 | 0.000 |
| S2 | 37.873 | −0.593 | −2.752 | 15.922 | −47.960 | 37.698 | 167.620 | −84.947 | −1294.165 | 0.000 |
| S3 | −1.772 | −0.283 | −6.000 | 20.742 | −37.504 | −67.496 | 174.278 | 691.009 | −2564.732 | 0.000 |
| S4 | 60.214 | −0.113 | −2.669 | 3.628 | −10.708 | 20.758 | 4.097 | −34.477 | −49.888 | 0.000 |
| S5 | −4.579 | −1.125 | 1.818 | −4.548 | 1.944 | 56.806 | −45.344 | −222.234 | 351.145 | 0.000 |
| S6 | −1.771 | −0.118 | −0.285 | −0.376 | 2.701 | 6.547 | −1.038 | −15.509 | −39.641 | 0.000 |
| S7 | −12.492 | −0.097 | −1.050 | 1.692 | 0.843 | −4.497 | −1.969 | 7.436 | 5.636 | 0.000 |
| S8 | −4.711 | −0.531 | 0.800 | −1.078 | 0.760 | −0.168 | −0.076 | −0.080 | 0.125 | 0.000 |

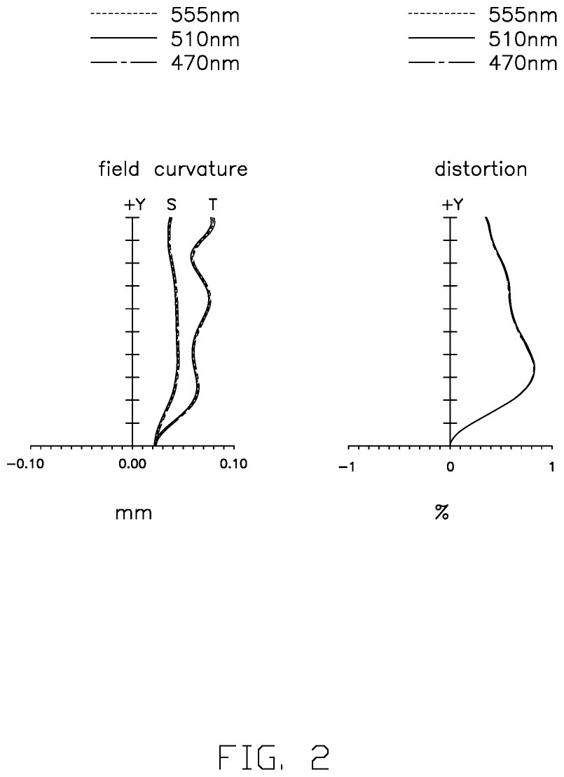

FIG. 2 shows field curvature curves and distortion curves of the optical imaging device 10 of the first embodiment, the field curvature curves represent the meridian field curvature and the sagittal field curvature, in which the maximum value of each of the sagittal field curve and the meridional field curve is less than 0.1 mm, indicating that good compensation is obtained. The distortion curves represent distortion values corresponding to different field angles, in which the maximum distortion is less than 1%, indicating that distortion has been corrected. As can be seen from FIG. 2, the optical imaging device 10 in the first embodiment has a good imaging quality.

### Second Embodiment

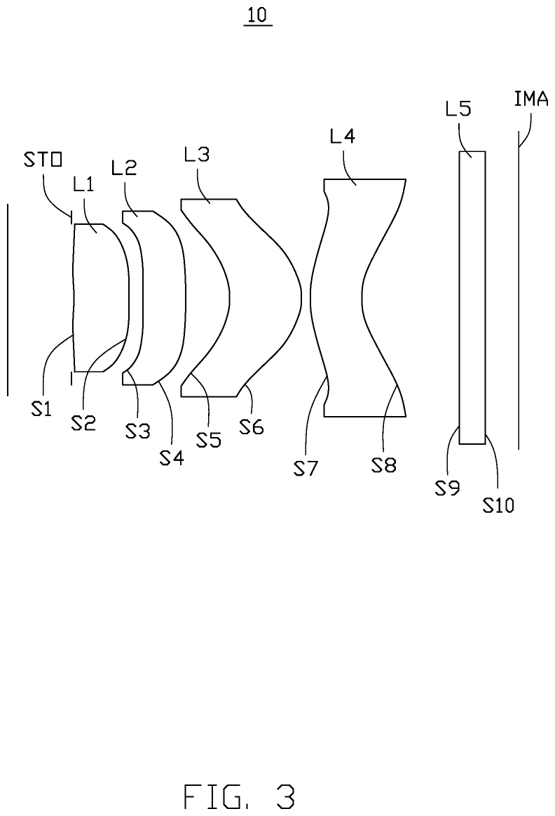

Referring to FIG. 3, the optical imaging device 10 includes, from the object side to the image side, a stop STO, a first lens L1 with a positive refractive power, a second lens L2 with a negative refractive power, a third lens L3 with a positive refractive power, a fourth lens L4 with a positive refractive power, and an optical filter L5.

The first lens L1, the second lens L2, the third lens L3, and the fourth lens L4 are made of plastic, and the optical filter L5 is made of glass.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is concave near the optical axis, and the image-side surface S6 of the third lens L3 is convex near the optical axis. The object-side surface S7 of the fourth lens L4 is convex near the optical axis, and the image-side surface S8 of the fourth lens L4 is concave near the optical axis.

A dispersion coefficient of the first lens L1 is 55.978, the dispersion coefficient of the second lens L2 is 20.373, the dispersion coefficient of the third lens L3 is 55.978, and the dispersion coefficient of the fourth lens L4 is 55.978.

When the optical imaging device 10 is used, rays from the object side enter the optical imaging device 10, successively pass through the stop STO, the first lens L1, the second lens L2, the third lens L3, the fourth lens L4, and the optical filter L5, and finally converge on the image plane IMA.

Table 3 shows characteristics of the optical imaging device 10. The reference wavelength of focal length, refractive index, and Abbe number is 558 nm, and the units of radius of curvature, thickness, and semi-diameter are in millimeters (mm).

TABLE 3
Second embodiment
f = 1.712 mm, TL = 2.272 mm, TL2 = 1.946 mm, TL3 = 1.267 mm, TL4 = 0.917 mm

| | | Type of | radius of | | | refractive | Abbe | semi- |
|---|---|---|---|---|---|---|---|---|
| Surface | Lens | surface | curvature | thickness | material | index | number | diameter |
| object- | | standard surface | infinite | 300.000 | | | | 193.506 |
| side | | | | | | | | |
| surface | | | | | | | | |
| STO | | standard surface | infinite | 0.015 | | | | 0.455 |
| S1 | first lens | aspheric surface | 2.500 | 0.342 | plastic | 1.54 | 56 | 0.460 |
| S2 | | aspheric surface | −3.448 | 0.076 | | | | 0.536 |
| S3 | second lens | aspheric surface | 16.113 | 0.250 | plastic | 1.66 | 20.4 | 0.543 |
| S4 | | aspheric surface | −5.565 | 0.260 | | | | 0.634 |
| S5 | third lens | aspheric surface | −0.620 | 0.419 | plastic | 1.54 | 56 | 0.658 |
| S6 | | aspheric surface | −0.493 | 0.050 | | | | 0.727 |
| S7 | fourth lens | aspheric surface | 0.880 | 0.300 | plastic | 1.54 | 56 | 0.770 |
| S8 | | aspheric surface | 0.485 | 0.580 | | | | 0.868 |
| S9 | optical filter | standard surface | infinite | | glass | 1.52 | 64.2 | 1.018 |
| S10 | | standard surface | infinite | | | | | 1.067 |
| IMA | | standard surface | infinite | | | | | 0.000 |

Table 4 shows the conic constant k and the high-order coefficients A4, A6, A8, A10, A12, A14, A16, A18, and A20 for the surfaces S1 to S8 of each aspheric lens in the second embodiment.

TABLE 4
aspherical coefficients

| surface | k | A4 | A6 | A8 | A10 | A12 | A14 | A16 | A18 | A20 |
|---|---|---|---|---|---|---|---|---|---|---|
| S1 | 2.329 | −0.074 | −2.262 | −1.710 | 25.754 | −54.522 | 23.217 | 138.430 | −1.578 | 0.000 |
| S2 | 37.873 | −0.593 | −2.752 | 15.922 | −47.960 | 37.698 | 167.620 | −84.947 | 1294.165 | 0.000 |
| S3 | −1.772 | −0.283 | −6.000 | 20.742 | −37.504 | −67.496 | 174.278 | 691.009 | −2564.732 | 0.000 |
| S4 | 60.214 | −0.113 | −2.669 | 3.628 | −10.708 | 20.758 | 4.097 | −34.477 | −49.888 | 0.000 |
| S5 | −1.828 | −0.217 | 4.498 | −81.594 | 643.671 | −3115.176 | 9921.761 | −1.954 | 2.126 | 0.000 |
| S6 | −2.044 | −0.133 | −1.366 | 3.448 | 6.129 | −43.095 | 76.207 | 81.250 | −362.644 | 0.000 |
| S7 | −2.947 | −0.689 | 1.245 | −6.372 | 35.926 | −150.449 | 408.213 | −677.261 | 622.134 | 0.000 |
| S8 | −4.046 | −0.310 | 0.725 | −2.642 | 7.195 | −12.439 | 13.131 | −7.880 | 2.250 | 0.000 |

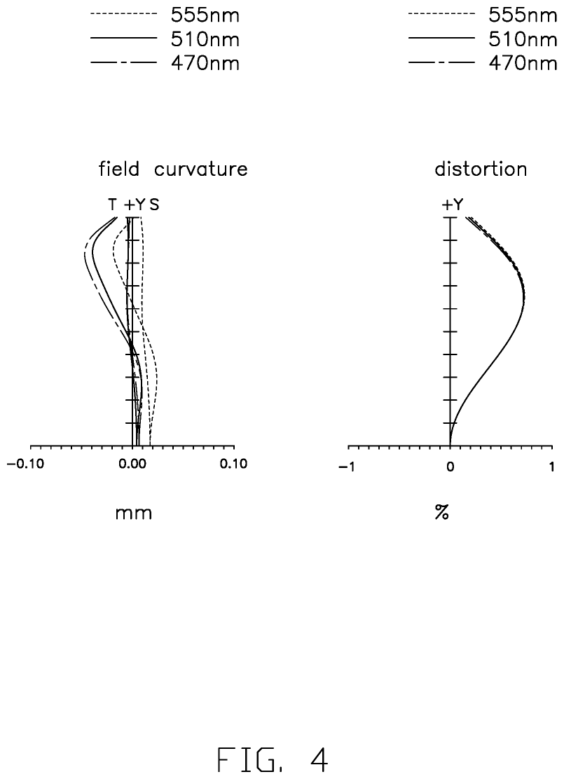

FIG. 4 shows field curvature curves and distortion curves of the optical imaging device 10 of the second embodiment, the field curvature curves represent the meridian field curvature and the sagittal field curvature, in which the maximum value of each of the sagittal field curve and the meridional field curve is less than 0.1 mm, indicating that good compensation is obtained. The distortion curves represent distortion values corresponding to different field angles, in which the maximum distortion is less than 1%, indicating that distortion has been corrected. As can be seen from FIG. 4, the optical imaging device 10 in the second embodiment has a good imaging quality.

### Third Embodiment

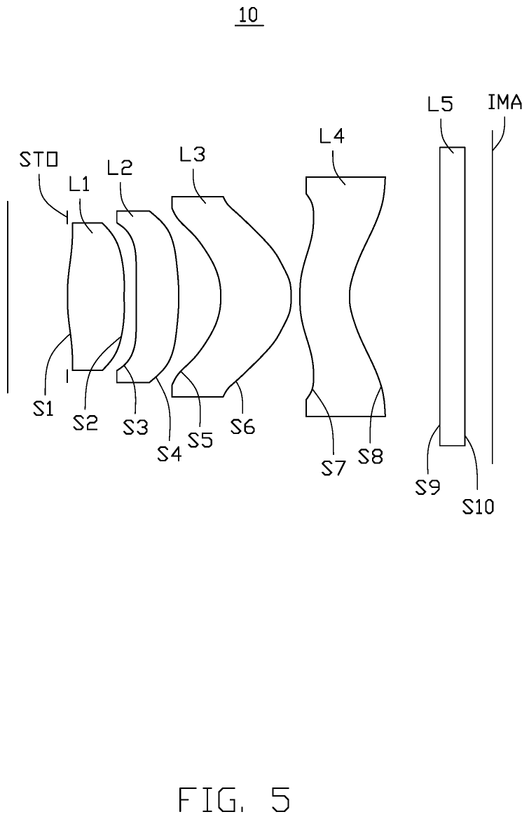

Referring to FIG. 5, the optical imaging device 10 includes, from the object side to the image side, a stop STO, a first lens L1 with a positive refractive power, a second lens L2 with a negative refractive power, a third lens L3 with a positive refractive power, a fourth lens L4 with a positive refractive power, and an optical filter L5.

The first lens L1, the second lens L2, the third lens L3, and the fourth lens L4 are made of plastic, and the optical filter L5 is made of glass.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is concave near the optical axis, and the image-side surface S6 of the third lens L3 is convex near the optical axis. The object-side surface S7 of the fourth lens L4 is convex near the optical axis, and the image-side surface S8 of the fourth lens L4 is concave near the optical axis.

A dispersion coefficient of the first lens L1 is 55.978, the dispersion coefficient of the second lens L2 is 20.373, the dispersion coefficient of the third lens L3 is 55.978, and the dispersion coefficient of the fourth lens L4 is 55.978.

When the optical imaging device 10 is used, rays from the object side enter the optical imaging device 10, successively pass through the stop STO, the first lens L1, the second lens L2, the third lens L3, the fourth lens L4, and the optical filter L5, and finally converge on the image plane IMA.

Table 5 shows characteristics of the optical imaging device 10. The reference wavelength of focal length, refractive index, and Abbe number is 558 nm, and the units of radius of curvature, thickness, and semi-diameter are in millimeters (mm).

TABLE 5
Third embodiment
f = 1.652 mm, TL = 2.213 mm, TL2 = 1.887 mm, TL3 = 1.208 mm, TL4 = 0.858 mm

| | | | radius of | | | refractive | Abbe | semi- |
|---|---|---|---|---|---|---|---|---|
| Surface | Lens | Type of surface | curvature | thickness | material | index | number | diameter |
| object-side surface | | standard surface | infinite | 300.000 | | | | 202.100 |
| STO | | standard surface | infinite | 0.015 | | | | 0.455 |
| S1 | first lens | aspheric surface | 2.300 | 0.342 | plastic | 1.54 | 56 | 0.462 |
| S2 | | aspheric surface | −3.448 | 0.076 | | | | 0.538 |
| S3 | second lens | aspheric surface | 16.113 | 0.250 | plastic | 1.66 | 20.4 | 0.544 |
| S4 | | aspheric surface | −5.565 | 0.260 | | | | 0.636 |
| S5 | third lens | aspheric surface | −0.620 | 0.419 | plastic | 1.54 | 56 | 0.659 |
| S6 | | aspheric surface | −0.493 | 0.050 | | | | 0.731 |
| S7 | fourth lens | aspheric surface | 0.893 | 0.300 | plastic | 1.54 | 56 | 0.759 |
| S8 | | aspheric surface | 0.498 | 0.550 | | | | 0.882 |
| S9 | optical filter | standard surface | infinite | 0.150 | glass | 1.52 | 64.2 | 1.037 |
| S10 | | standard surface | infinite | 0.158 | | | | 1.096 |
| IMA | | standard surface | infinite | | | | | 0.000 |

Table 6 shows the conic constant k and the high-order coefficients A4, A6, A8, A10, A12, A14, A16, A18, and A20 for the surfaces S1 to S8 of each aspheric lens in the third embodiment.

TABLE 6
aspherical coefficients

| surface | k | A4 | A6 | A8 | A10 | A12 | A14 | A16 | A18 | A20 |
|---|---|---|---|---|---|---|---|---|---|---|
| S1 | 2.329 | −0.074 | −2.262 | −1.710 | 25.754 | −54.522 | 23.217 | 138.430 | −1.578 | 0.000 |
| S2 | 37.873 | −0.593 | −2.752 | 15.922 | −47.960 | 37.698 | 167.620 | −84.947 | −1294.165 | 0.000 |
| S3 | −1.772 | −0.283 | −6.000 | 20.742 | −37.504 | −67.496 | 174.278 | 691.009 | −2564.732 | 0.000 |
| S4 | 60.214 | −0.113 | −2.669 | 3.628 | −10.708 | 20.758 | 4.097 | −34.477 | −49.888 | 0.000 |
| S5 | −1.254 | −0.072 | 5.917 | −97.438 | 702.781 | −3192.117 | 9878.736 | −1.937 | 2.125 | 0.000 |
| S6 | −1.730 | 0.050 | −1.744 | 2.032 | 14.532 | −64.843 | 99.340 | 114.833 | −470.959 | 0.000 |
| S7 | −2.297 | −0.938 | 1.497 | −6.684 | 33.787 | −138.879 | 395.949 | −711.518 | 712.650 | 0.000 |
| S8 | −4.049 | −0.478 | 0.992 | −3.454 | 9.420 | −16.428 | 17.692 | −11.182 | 3.705 | 0.000 |

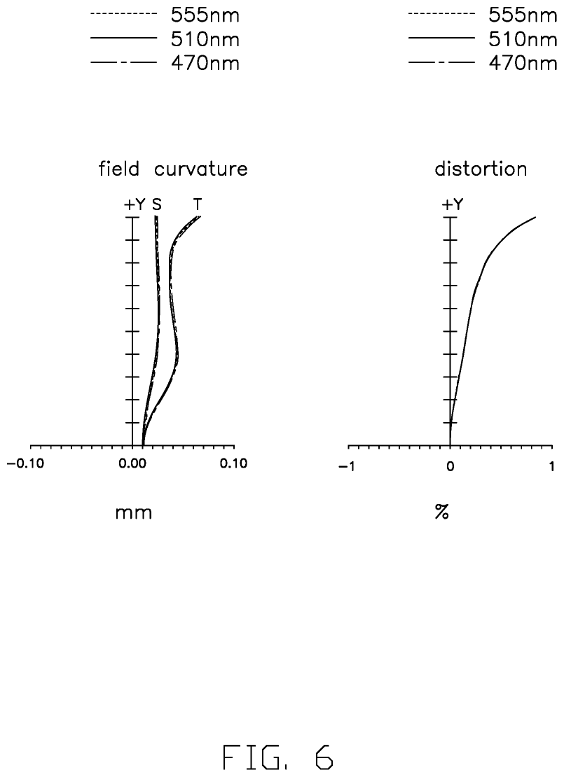

FIG. 6 shows field curvature curves and distortion curves of the optical imaging device 10 of the third embodiment, the field curvature curves represent the meridian field curvature and the sagittal field curvature, in which the maximum value of each of the sagittal field curve and the meridional field curve is less than 0.1 mm, indicating that good compensation is obtained. The distortion curves represent distortion values corresponding to different field angles, in which the maximum distortion is less than 1%, indicating that distortion has been corrected. As can be seen from FIG. 6, the optical imaging device 10 in the third embodiment has a good imaging quality.

### Fourth Embodiment

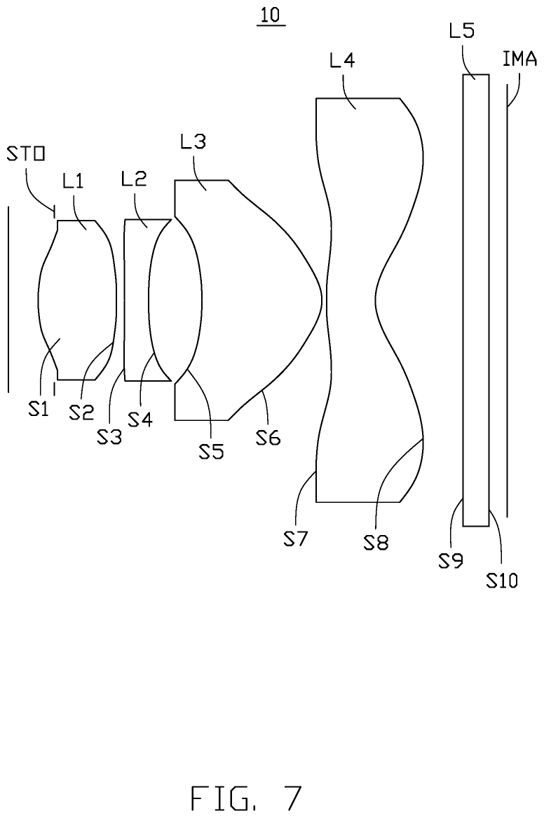

Referring to FIG. 7, the optical imaging device 10 includes, from the object side to the image side, a stop STO, a first lens L1 with a positive refractive power, a second lens L2 with a negative refractive power, a third lens L3 with a positive refractive power, a fourth lens L4 with a positive refractive power, and an optical filter L5.

The first lens L1, the second lens L2, the third lens L3, and the fourth lens L4 are made of plastic, and the optical filter L5 is made of glass.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is concave near the optical axis, and the image-side surface S6 of the third lens L3 is convex near the optical axis. The object-side surface S7 of the fourth lens L4 is convex near the optical axis, and the image-side surface S8 of the fourth lens L4 is concave near the optical axis.

A dispersion coefficient of the first lens L1 is 55.978, the dispersion coefficient of the second lens L2 is 20.373, the dispersion coefficient of the third lens L3 is 55.978, and the dispersion coefficient of the fourth lens L4 is 55.978.

When the optical imaging device 10 is used, rays from the object side enter the optical imaging device 10, successively pass through the stop STO, the first lens L1, the second lens L2, the third lens L3, the fourth lens L4, and the optical filter L5, and finally converge on the image plane IMA.

Table 7 shows characteristics of the optical imaging device 10. The reference wavelength of focal length, refractive index, and Abbe number is 558 nm, and the units of radius of curvature, thickness, and semi-diameter are in millimeters (mm).

TABLE 7
Fourth embodiment
f = 2.872 mm, TL = 3.223 mm, TL2 = 2.958 mm, TL3 = 1.531 mm, TL4 = 1.089 mm

| | | | radius of | | | refractive | Abbe | semi- |
|---|---|---|---|---|---|---|---|---|
| Surface | Lens | Type of surface | curvature | thickness | material | index | number | diameter |
| object- | | standard surface | infinite | 350.000 | | | | 283.854 |
| side | | | | | | | | |
| surface | | | | | | | | |
| STO | | standard surface | infinite | 0.125 | | | | 0.700 |
| S1 | first lens | aspheric surface | 1.582 | 0.645 | plastic | 1.54 | 56 | 0.770 |
| S2 | | aspheric surface | −6.575 | 0.065 | | | | 0.850 |
| S3 | second lens | aspheric surface | −25.698 | 0.200 | plastic | 1.66 | 20.4 | 0.865 |
| S4 | | aspheric surface | 4.211 | 0.446 | | | | 0.865 |
| S5 | third lens | aspheric surface | −2.622 | 0.981 | plastic | 1.54 | 56 | 0.915 |
| S6 | | aspheric surface | −0.663 | 0.050 | | | | 1.280 |
| S7 | fourth lens | aspheric surface | 3.642 | 0.392 | plastic | 1.54 | 56 | 1.790 |
| S8 | | aspheric surface | 0.592 | 0.729 | | | | 2.130 |
| S9 | optical filter | standard surface | infinite | 0.210 | glass | 1.52 | 64.2 | 2.400 |
| S10 | | standard surface | infinite | 0.150 | | | | 2.213 |
| IMA | | standard surface | infinite | | | | | 0.000 |

Table 8 shows the conic constant k and the high-order coefficients A4, A6, A8, A10, A12, A14, A16, A18, and A20 for the surfaces S1 to S8 of each aspheric lens in the fourth embodiment.

TABLE 8
aspherical coefficients

| surface | k | A4 | A6 | A8 | A10 | A12 | A14 | A16 | A18 | A20 |
|---|---|---|---|---|---|---|---|---|---|---|
| S1 | 0.325 | −0.044 | −0.109 | 0.189 | −0.260 | −0.883 | 1.119 | −0.345 | 2.168 | 0.000 |
| S2 | 12.764 | −0.091 | −0.292 | 0.227 | 0.104 | −0.104 | −0.023 | −0.061 | −0.436 | 0.000 |
| S3 | −7.052 | 0.039 | −0.353 | 0.530 | −0.082 | 0.022 | 0.813 | −1.964 | 0.733 | 0.000 |
| S4 | 20.710 | 0.147 | −0.287 | 0.393 | −0.012 | −0.356 | 0.167 | 0.241 | 0.570 | 0.000 |
| S5 | −19.789 | −0.184 | 0.093 | −0.236 | 0.125 | 0.147 | −0.073 | −0.126 | −0.045 | 0.000 |
| S6 | −3.914 | −0.180 | 0.056 | 0.013 | −0.027 | 2.575 | 5.412 | 3.179 | 3.356 | 0.000 |
| S7 | −21.237 | −0.155 | 0.072 | −0.20 | 5.164 | −4.432 | −1.783 | −5.661 | 4.656 | 0.000 |
| S8 | −4.980 | −0.091 | 0.044 | −0.017 | 4.067 | −4.749 | −4.629 | 2.582 | −3.193 | 0.000 |

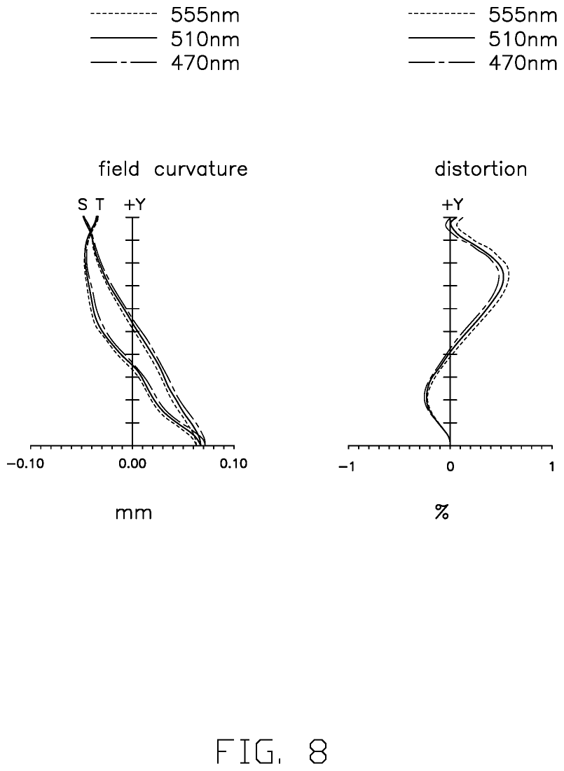

FIG. 8 shows field curvature curves and distortion curves of the optical imaging device 10 of the fourth embodiment, the field curvature curves represent the meridian field curvature and the sagittal field curvature, in which the maximum value of each of the sagittal field curve and the meridional field curve is less than 0.1 mm, indicating that good compensation is obtained. The distortion curves represent distortion values corresponding to different field angles, in which the maximum distortion is less than 1%, indicating that distortion has been corrected. As can be seen from FIG. 8, the optical imaging device 10 in the fourth embodiment has a good imaging quality.

### Fifth Embodiment

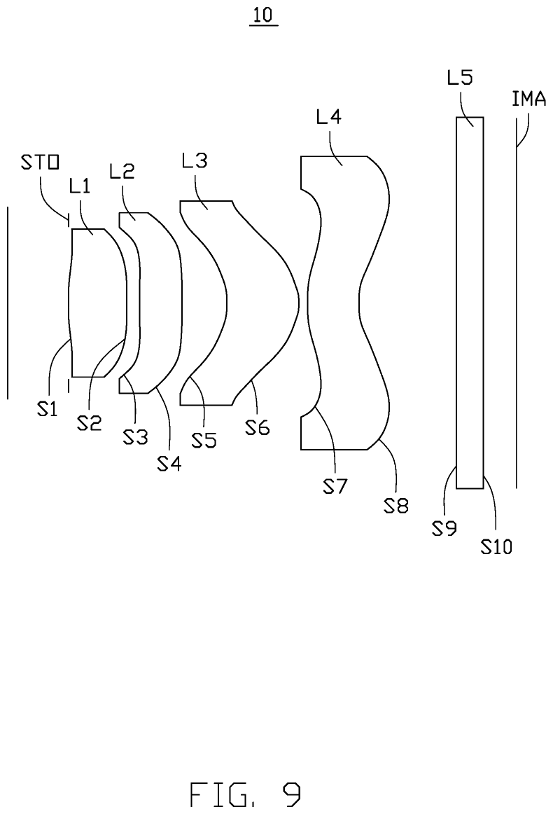

Referring to FIG. 9, the optical imaging device 10 includes, from the object side to the image side, a stop STO, a first lens L1 with a positive refractive power, a second lens L2 with a negative refractive power, a third lens L3 with a positive refractive power, a fourth lens L4 with a positive refractive power, and an optical filter L5.

The first lens L1, the second lens L2, the third lens L3, and the fourth lens L4 are made of plastic, and the optical filter L5 is made of glass.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is concave near the optical axis, and the image-side surface S6 of the third lens L3 is convex near the optical axis. The object-side surface S7 of the fourth lens L4 is convex near the optical axis, and the image-side surface S8 of the fourth lens L4 is concave near the optical axis.

A dispersion coefficient of the first lens L1 is 56.00, the dispersion coefficient of the second lens L2 is 20.400, the dispersion coefficient of the third lens L3 is 56.000, and the dispersion coefficient of the fourth lens L4 is 56.000.

When the optical imaging device 10 is used, rays from the object side enter the optical imaging device 10, successively pass through the stop STO, the first lens L1, the second lens L2, the third lens L3, the fourth lens L4, and the optical filter L5, and finally converge on the image plane IMA.

Table 9 shows characteristics of the optical imaging device 10. The reference wavelength of focal length, refractive index, and Abbe number is 558 nm, and the units of radius of curvature, thickness, and semi-diameter are in millimeters (mm).

TABLE 9
Fifth embodiment
f = 1.73 mm, TL = 2.638 mm, TL2 = 2.220 mm, TL3 = 1.702 mm, TL4 = 1.232 mm

| | | | radius of | | | refractive | Abbe | semi- |
|---|---|---|---|---|---|---|---|---|
| Surface | Lens | Type of surface | curvature | thickness | material | index | number | diameter |
| object- | | standard surface | infinite | 300.000 | | | | 208.487 |
| side | | | | | | | | |
| surface | | | | | | | | |
| STO | | standard surface | infinite | 0.015 | | | | 0.434 |
| S1 | first lens | aspheric surface | 2.577 | 0.342 | plastic | 1.54 | 56 | 0.470 |
| S2 | | aspheric surface | −3.448 | 0.176 | | | | 0.540 |
| S3 | second lens | aspheric surface | 16.113 | 0.250 | plastic | 1.66 | 20.4 | 0.550 |
| S4 | | aspheric surface | −5.565 | 0.268 | | | | 0.650 |
| S5 | third lens | aspheric surface | −0.620 | 0.419 | plastic | 1.54 | 56 | 0.710 |
| S6 | | aspheric surface | −0.493 | 0.051 | | | | 0.750 |
| S7 | fourth lens | aspheric surface | 0.899 | 0.301 | plastic | 1.54 | 56 | 0.830 |
| S8 | | aspheric surface | 0.494 | 0.581 | | | | 1.065 |
| S9 | optical filter | standard surface | infinite | 0.150 | glass | 1.52 | 64.2 | 1.350 |
| S10 | | standard surface | infinite | 0.200 | | | | 1.350 |
| IMA | | standard surface | infinite | | | | | 0.000 |

Table 10 shows the conic constant k and the high-order coefficients A4, A6, A8, A10, A12, A14, A16, A18, and A20 for the surfaces S1 to S8 of each aspheric lens in the fifth embodiment.

TABLE 10
aspherical coefficients

| surface | k | A4 | A6 | A8 | A10 | A12 | A14 | A16 | A18 | A20 |
|---|---|---|---|---|---|---|---|---|---|---|
| S1 | 2.329 | −0.074 | −2.626 | −1.710 | 25.754 | −54.522 | 23.217 | 138.430 | −1.578 | 0.000 |
| S2 | 37.873 | −0.593 | −2.752 | 15.922 | −47.960 | 37.698 | 167.620 | −84.947 | −1294.165 | 0.000 |
| S3 | −1.772 | −0.283 | −6.000 | 20.742 | −37.504 | −67.496 | 174.278 | 691.009 | −2564.732 | 0.000 |
| S4 | 60.214 | −0.113 | −2.669 | 3.628 | −10.708 | 20.758 | 4.097 | −34.477 | −49.888 | 0.000 |
| S5 | −4.579 | −1.125 | 1.818 | −4.548 | 1.944 | 56.806 | −45.344 | −222.234 | 351.145 | 0.000 |
| S6 | −1.771 | −0.118 | −0.285 | −0.376 | 2.701 | 6.547 | −1.038 | −15.509 | −39.641 | 0.000 |
| S7 | −12.492 | −0.097 | −1.050 | 1.692 | 0.843 | −4.497 | −1.969 | 7.436 | 5.636 | 0.000 |
| S8 | −4.711 | −0.531 | 0.800 | −1.078 | 0.760 | −0.168 | −0.076 | −0.080 | 0.125 | 0.000 |

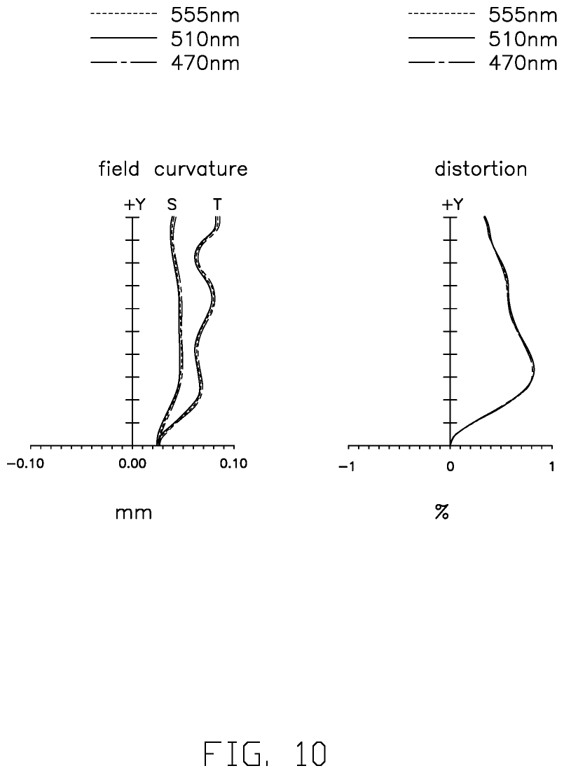

FIG. 10 shows field curvature curves and distortion curves of the optical imaging device 10 of the fifth embodiment, the field curvature curves represent the meridian field curvature and the sagittal field curvature, in which the maximum value of each of the sagittal field curve and the meridional field curve is less than 0.1 mm, indicating that good compensation is obtained. The distortion curves represent distortion values corresponding to different field angles, in which the maximum distortion is less than 1%, indicating that distortion has been corrected. As can be seen from FIG. 10, the optical imaging device 10 in the fifth embodiment has a good imaging quality.

### Sixth Embodiment

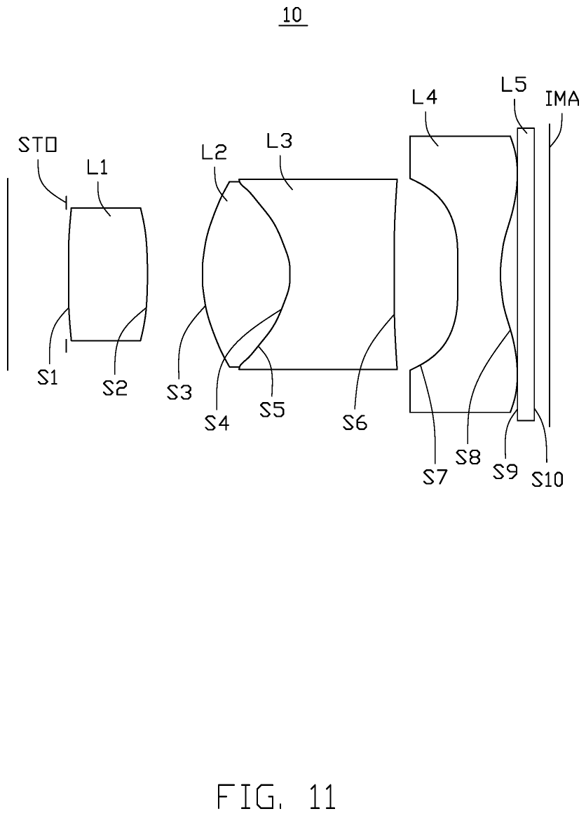

Referring to FIG. 11, the optical imaging device 10 includes, from the object side to the image side, a stop STO, a first lens L1 with a positive refractive power, a second lens L2 with a negative refractive power, a third lens L3 with a positive refractive power, a fourth lens L4 with a positive refractive power, and an optical filter L5.

The first lens L1, the second lens L2, the third lens L3, and the fourth lens L4 are made of plastic, and the optical filter L5 is made of glass.

The object-side surface S1 of the first lens L1 is convex near the optical axis, and the image-side surface S2 of the first lens L1 is convex near the optical axis. The object-side surface S3 of the second lens L2 is convex near the optical axis, and the image-side surface S4 of the second lens L2 is convex near the optical axis. The object-side surface S5 of the third lens L3 is concave near the optical axis, and the image-side surface S6 of the third lens L3 is concave near the optical axis. The object-side surface S7 of the fourth lens L4 is concave near the optical axis, and the image-side surface S8 of the fourth lens L4 is concave near the optical axis. The image-side surface S4 of the second lens L2 is adhered to the object-side surface S5 of the third lens L3.

A dispersion coefficient of the first lens L1 is 56.00, the dispersion coefficient of the second lens L2 is 45.400, the dispersion coefficient of the third lens L3 is 27.500, and the dispersion coefficient of the fourth lens L4 is 56.000.

When the optical imaging device 10 is used, rays from the object side enter the optical imaging device 10, successively pass through the stop STO, the first lens L1, the second lens L2, the third lens L3, the fourth lens L4, and the optical filter L5, and finally converge on the image plane IMA.

Table 11 shows characteristics of the optical imaging device 10. The reference wavelength of focal length, refractive index, and Abbe number is 558 nm, and the units of radius of curvature, thickness, and semi-diameter are in millimeters (mm).

TABLE 11
Sixth embodiment
f = 1.730 mm, TL = 3.000 mm, TL2 = 2.167 mm, TL3 = 0.970 mm, TL4 = 0.309 mm

| | | | radius of | | | refractive | Abbe | semi- |
|---|---|---|---|---|---|---|---|---|
| Surface | Lens | Type of surface | curvature | thickness | material | index | number | diameter |
| object- | | standard surface | infinite | 300.000 | | | | 208.487 |
| side | | | | | | | | |
| surface | | | | | | | | |
| STO | | standard surface | infinite | 0.015 | | | | 0.434 |
| S1 | first lens | aspheric surface | 3.408 | 0.482 | plastic | 1.54 | 56 | 0.369 |
| S2 | | aspheric surface | −11.947 | 0.351 | | | | 0.521 |
| S3 | second lens | aspheric surface | 1.454 | 0.547 | plastic | 1.74 | 45.4 | 0.734 |
| S4 | | aspheric surface | 1.454 | 0.547 | | | | 0.734 |
| S5 | third lens | aspheric surface | −0.721 | 0.650 | plastic | 1.76 | 27.5 | 0.735 |
| S6 | | aspheric surface | 54.762 | 0.395 | | | | 0.754 |
| S7 | fourth lens | aspheric surface | −39.509 | 0.266 | plastic | 1.54 | 56 | 0.757 |
| S8 | | aspheric surface | 1.071 | 0.109 | | | | 1.081 |
| S9 | optical filter | standard surface | infinite | 0.100 | glass | 1.52 | 64.2 | 1.109 |
| S10 | | standard surface | infinite | 0.100 | | | | 1.144 |
| IMA | | standard surface | infinite | | | | | 0.000 |

Table 12 shows the conic constant k and the high-order coefficients A4, A6, A8, A10, A12, A14, A16, A18, and A20 for the surfaces S1 to S8 of each aspheric lens in the sixth embodiment.

TABLE 12
aspherical coefficients

| surface | k | A4 | A6 | A8 | A10 | A12 | A14 | A16 | A18 | A20 |
|---|---|---|---|---|---|---|---|---|---|---|
| S1 | −27.227 | −0.210 | −0.154 | −0.600 | 0.000 | 0.000 | 0.000 | 0.000 | 0.000 | 0.000 |
| S2 | −5.064 | −0.509 | 0.140 | −0.402 | 0.000 | 0.000 | 0.000 | 0.000 | 0.000 | 0.000 |
| S3 | 1.047 | −0.202 | 0.040 | −0.129 | 0.000 | 0.000 | 0.000 | 0.000 | 0.000 | 0.000 |
| S4 | 60.214 | −0.113 | −2.669 | 3.628 | 0.000 | 0.000 | 0.000 | 0.000 | 0.000 | 0.000 |
| S5 | −0.191 | 1.015 | −2.192 | 3.089 | 0.000 | 0.000 | 0.000 | 0.000 | 0.000 | 0.000 |
| S6 | −9.843 | 0.119 | −0.081 | −0.063 | 0.000 | 0.000 | 0.000 | 0.000 | 0.000 | 0.000 |
| S7 | −9.903 | −1.123 | 1.029 | −1.188 | 0.000 | 0.000 | 0.000 | 0.000 | 0.000 | 0.000 |
| S8 | −12.559 | −0.151 | 0.049 | −0.028 | 0.000 | 0.000 | 0.000 | 0.000 | 0.000 | 0.000 |

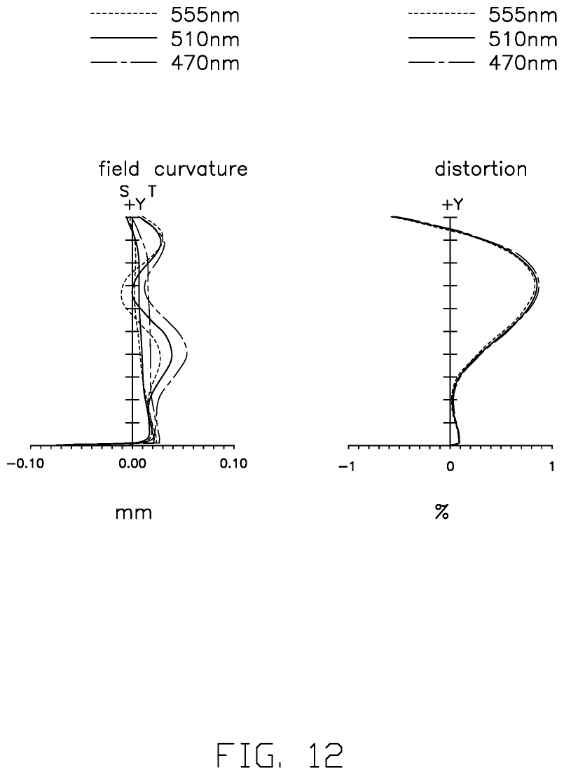

FIG. 12 shows field curvature curves and distortion curves of the optical imaging device 10 of the sixth embodiment, the field curvature curves represent the meridian field curvature and the sagittal field curvature, in which the maximum value of each of the sagittal field curve and the meridional field curve is less than 0.1 mm, indicating that good compensation is obtained. The distortion curves represent distortion values corresponding to different field angles, in which the maximum distortion is less than 1%, indicating that distortion has been corrected. As can be seen from FIG. 12, the optical imaging device 10 in the sixth embodiment has a good imaging quality.

Table 13 shows values of Imgh/f, TL/f, TL2/f, TL3/f, TL4/f, f/EPD, and V1/(V2+V3+V4) of the optical imaging device 10 in the first to sixth embodiments.

TABLE 13

| | First | Second | Third | Fourth | Fifth | Sixth |
|---|---|---|---|---|---|---|
| | embodiment | embodiment | embodiment | embodiment | embodiment | embodiment |
| Imgh/f | 0.693 | 0.701 | 0.726 | 0.796 | 0.694 | 0.694 |
| TL/f | 1.326 | 1.327 | 1.340 | 1.122 | 1.525 | 1.734 |
| TL2/f | 1.151 | 1.137 | 1.142 | 1.030 | 1.283 | 1.253 |
| TL3/f | 0.741 | 0.740 | 0.731 | 0.533 | 0.984 | 0.561 |
| TL4/f | 0.538 | 0.536 | 0.519 | 0.379 | 0.712 | 0.179 |
| f/EPD | 1.994 | 1.881 | 1.815 | 2.051 | 1.993 | 2.344 |
| V1/(V2 + | 0.423 | 0.423 | 0.423 | 0.423 | 0.423 | 0.434 |
| V3 + V4) | | | | | | |

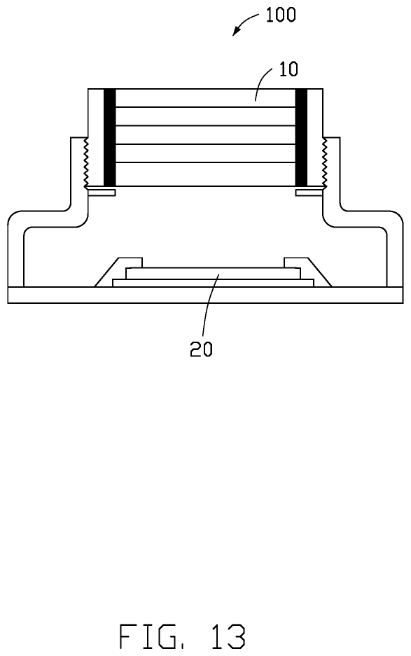

Referring to FIG. 13, an embodiment of an imaging module 100 is further provided, which includes the optical imaging device 10 and an optical sensor 20. The optical sensor 20 is arranged on the image side of the optical imaging device 10.

The optical sensor 20 can be a CMOS (complementary metal oxide semiconductor) sensor or a charge coupled device (CCD).

In the imaging module 100, controlling the values of Imgh/f and TL/f improves image resolution of the optical imaging device 10, the imaging quality of the optical imaging device 10 can be stable, the total optical length of the optical imaging device 10 can be shortened, so that the optical imaging device 10 can be lightweight and compact. Through arrangement of the refractive powers and the contouring of each lens, it is possible to increase performance of each lens, reduce image error and image degradation, and improve the image resolution of the optical imaging device 10.

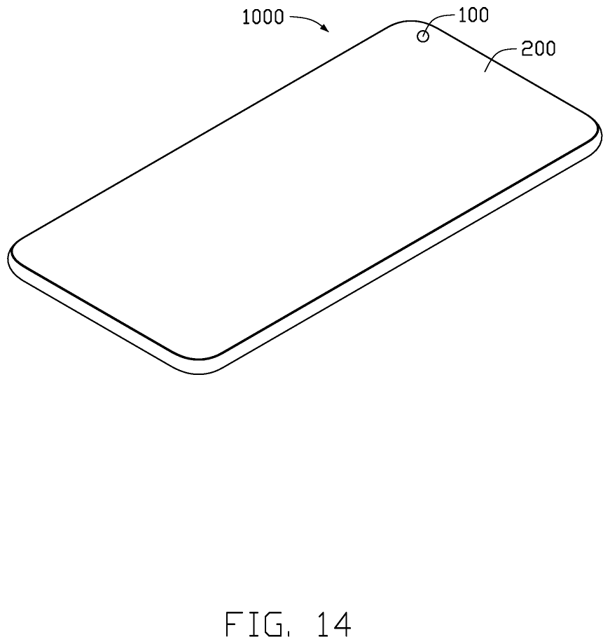

Referring to FIG. 14, an embodiment of an electronic device 1000 is further provided, which includes the imaging module 100 and a housing 200. The imaging module 100 is mounted on the housing 200.

The electronic device 200 can be a smart phone, a tablet computer, a notebook computer, an e-book reader, a portable multimedia player (PMP), a portable telephone, a video telephone, a digital camera, a mobile medical device, a wearable device, etc.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. An optical imaging device, from an object side to an image side, comprising:
a first lens having a positive refractive power;
a second lens having a negative refractive power;
a third lens having a positive refractive power, wherein an object-side surface of the third lens is concave near an optical axis of the optical imaging device; and
a fourth lens having a positive refractive power, wherein an image-side surface of the fourth lens is concave near the optical axis;
wherein the optical imaging device satisfies the following formulas:
0.4<Imgh/f<1.4 and 0.7<TL/f<2;
wherein, Imgh is a half of an image height corresponding to a maximum field of view of the optical imaging device, f is an effective focal length of the optical imaging device, and TL is a distance from an object-side surface of the first lens to an image plane of the optical imaging device along the optical axis.

2. The optical imaging device of claim 1, wherein an object-side surface of the second lens, an image-side surface of the second lens, the object-side surface of the third lens, an image-side surface of the third lens, an object-side surface of the fourth lens, and the image-side surface of the fourth lens are aspherical.

3. The optical imaging device of claim 1, wherein the object-side surface of the first lens is convex near the optical axis, and an image-side surface of the first lens is convex near the optical axis.

4. The optical imaging device of claim 1, further satisfying the following formula:
0.6<TL2/f<1.8;
wherein TL2 is a distance from an object-side surface of the second lens to the image plane along the optical axis.

5. The optical imaging device of claim 1, further satisfying the following formula:
0.3<TL3/f<1;
wherein TL3 is a distance from the object-side surface of the third lens to the image plane along the optical axis.

6. The optical imaging device of claim 1, further satisfying the following formula:
0.1<TL4/f<0.5;
wherein, TL4 is a distance from an object-side surface of the fourth lens to the image plane along the optical axis.

7. The optical imaging device of claim 1, further satisfying the following formula:
1.1<f/EPD<3.9;
wherein EPD is an entrance pupil diameter of the optical imaging device.

8. The optical imaging device of claim 1, further satisfying the following formula:
0.42<V1/(V2+V3+V4)<0.44;
wherein V1 is a dispersion coefficient of the first lens, V2 is a dispersion coefficient of the second lens, V3 is a dispersion coefficient of the third lens, and V4 is a dispersion coefficient of the fourth lens.

9. An imaging module, comprising:
an optical imaging device, from an object side to an image side, comprising:
a first lens having a positive refractive power;
a second lens having a negative refractive power;
a third lens having a positive refractive power, wherein an object-side surface of the third lens is concave near an optical axis of the optical imaging device; and
a fourth lens having a positive refractive power, wherein an image-side surface of the fourth lens is concave near the optical axis; and
an optical sensor arranged on the image side of the optical imaging device;
wherein the optical imaging device satisfies the following formulas:
0.4<Imgh/f<1.4 and 0.7<TL/f<2;
wherein, Imgh is a half of an image height corresponding to a maximum field of view of the optical imaging device, f is an effective focal length of the optical imaging device, and TL is a distance from an object-side surface of the first lens to an image plane of the optical imaging device along the optical axis.

10. The imaging module of claim 9, wherein an object-side surface of the second lens, an image-side surface of the second lens, the object-side surface of the third lens, an image-side surface of the third lens, an object-side surface of the fourth lens, and the image-side surface of the fourth lens are aspherical.

11. The imaging module of claim 9, wherein the object-side surface of the first lens is convex near the optical axis, and an image-side surface of the first lens is convex near the optical axis.

12. The imaging module of claim 9, wherein the optical imaging device further satisfies the following formula:
0.6<TL2/f<1.8;
wherein TL2 is a distance from an object-side surface of the second lens to the image plane along the optical axis.

13. The imaging module of claim 9, wherein the optical imaging device further satisfies the following formula:
0.3<TL3/f<1;
wherein TL3 is a distance from the object-side surface of the third lens to the image plane along the optical axis.

14. The imaging module of claim 9, wherein the optical imaging device further satisfies the following formula:
0.1<TL4/f<0.5;
wherein, TL4 is a distance from an object-side surface of the fourth lens to the image plane along the optical axis.

15. The imaging module of claim 9, wherein the optical imaging device further satisfies the following formula:
1.1<f/EPD<3.9;
wherein EPD is an entrance pupil diameter of the optical imaging device.

16. The imaging module of claim 9, wherein the optical imaging device further satisfies the following formula:
0.42<V1/(V2+V3+V4)<0.44;
wherein V1 is a dispersion coefficient of the first lens, V2 is a dispersion coefficient of the second lens, V3 is a dispersion coefficient of the third lens, and V4 is a dispersion coefficient of the fourth lens.

17. An imaging module, comprising:
a housing; and
an imaging module mounted on the housing, the imaging module comprising:
an optical imaging device, from an object side to an image side, comprising:
a first lens having a positive refractive power;
a second lens having a negative refractive power;
a third lens having a positive refractive power, wherein an object-side surface of the third lens is concave near an optical axis of the optical imaging device; and
a fourth lens having a positive refractive power, wherein an image-side surface of the fourth lens is concave near the optical axis; and
an optical sensor arranged on the image side of the optical imaging device;
wherein the optical imaging device satisfies the following formulas:
0.4<Imgh/f<1.4 and 0.7<TL/f<2;
wherein, Imgh is a half of an image height corresponding to a maximum field of view of the optical imaging device, f is an effective focal length of the optical imaging device, and TL is a distance from an object-side surface of the first lens to an image plane of the optical imaging device along the optical axis.

18. The electronic device of claim 17, wherein an object-side surface of the second lens, an image-side surface of the second lens, the object-side surface of the third lens, an image-side surface of the third lens, an object-side surface of the fourth lens, and the image-side surface of the fourth lens are aspherical.

19. The electronic device of claim 17, wherein the object-side surface of the first lens is convex near the optical axis, and an image-side surface of the first lens is convex near the optical axis.

20. The electronic device of claim 17, wherein the optical imaging device further satisfies the following formula:
0.6<TL2/f<1.8;
wherein TL2 is a distance from an object-side surface of the second lens to the image plane along the optical axis.
